(19) United States
(12) Patent Application Publication
(10) Pub. No.: US 2026/0084099 A1
(43) Pub. Date: Mar. 26, 2026

(54) Gas Separation Membrane, Method For Producing Gas Separation Membrane, And Gas Separation Apparatus

(71) Applicant: SEIKO EPSON CORPORATION, Tokyo (JP)

(72) Inventor: Taisuke NAKASHIMA, Chino (JP)

(21) Appl. No.: 19/338,299

(22) Filed: Sep. 24, 2025

(30) Foreign Application Priority Data
Sep. 25, 2024 (JP) 2024-166182

(51) Int. Cl. B01D 53/22; B01D 67/00; B01D 69/02; B01D 69/10; B01D 71/70

(52) U.S. Cl. CPC B01D 53/228; B01D 67/0002; B01D 69/02; B01D 69/105; B01D 71/70; B01D 2257/504; B01D 2258/06; B01D 2325/04; B01D 2325/06

(57) ABSTRACT

A gas separation membrane for separating carbon dioxide includes: a separation layer formed of a polymer material and having a function of selecting and separating carbon dioxide; and a porous substrate including a first porous layer and a second porous layer. The gas separation membrane has a layer thickness T1 of 0.1 μm or more and 10.0 μm or less, an average pore diameter d1 of 10 nm or more and 10,000 nm or less, an aperture ratio A1 of 40% or more and 80% or less, a maximum height roughness R1 of 1 nm or more and 200 nm or less, a layer thickness T2 of 10 μm or more and 1,000 μm or less, a ratio d2/d1 of an average pore diameter d2 to the average pore diameter d1 of 1.1 or more and 10,000 or less, and a ratio A2/A1 of an aperture ratio A2 to the aperture ratio A1 of 1.1 or more and 2.0 or less.

The present application is based on, and claims priority from JP Application Serial Number 2024-166182, filed Sep. 25, 2024, the disclosure of which is hereby incorporated by reference herein in its entirety.

### BACKGROUND

### 1. Technical Field

The present disclosure relates to a gas separation membrane, a method for producing a gas separation membrane, and a gas separation apparatus.

### 2. Related Art

In order to implement carbon neutrality or carbon minus, a technique is being considered to absorb and collect carbon dioxide discharged from thermal power plants, boiler facilities, or the like, and carbon dioxide in the atmosphere. As that technique, there has been known a membrane separation method of separating carbon dioxide using a gas separation membrane.

For example, JP-A-2024-042578 discloses a gas separation membrane that selects and separates carbon dioxide from a mixed gas containing the carbon dioxide, and includes a porous layer, a first resin layer, and a second resin layer. The first resin layer is provided between the porous layer and the second resin layer, is formed of an organopolysiloxane, and has a porosity higher than that of the second resin layer. The second resin layer is formed of an organopolysiloxane and chemically bonded to the first resin layer.

Such a gas separation membrane has high gas permeability for carbon dioxide and excellent mechanical strength.

JP-A-2024-042578 is an example of the related art.

In the membrane separation method, energy is required to create a differential pressure across the gas separation membrane. In order to reduce the energy consumption, it is necessary to further increase gas selectivity and gas permeability for carbon dioxide without impairing the mechanical strength of the gas separation membrane.

### SUMMARY

A gas separation membrane according to an application example of the present disclosure is a gas separation membrane for permeating and separating carbon dioxide from a mixed gas containing the carbon dioxide, and includes: a separation layer formed of a polymer material and having a function of selecting and separating carbon dioxide; and a porous substrate including a first porous layer in contact with the separation layer and a second porous layer provided on the first porous layer on a side opposite to the separation layer, in which when a layer thickness of the first porous layer is denoted by T1, an average pore diameter of the first porous layer is denoted by d1, an aperture ratio of the first porous layer is denoted by A1, and a maximum height roughness of a surface of the first porous layer facing the separation layer is denoted by R1, the layer thickness T1 is 0.1 μm or more and 10.0 μm or less, the average pore diameter d1 is 10 nm or more and 10,000 nm or less, the aperture ratio A1 is 40% or more and 80% or less, and the maximum height roughness R1 is 1 nm or more and 200 nm or less, and when a layer thickness of the second porous layer is denoted by T2, an average pore diameter of the second porous layer is denoted by d2, and an aperture ratio of the second porous layer is denoted by A2, the layer thickness T2 is 10 μm or more and 1,000 μm or less, a ratio d2/d1 of the average pore diameter d2 to the average pore diameter d1 is 1.1 or more and 10,000 or less, and a ratio A2/A1 of the aperture ratio A2 to the aperture ratio A1 is 1.1 or more and 2.0 or less.

A method for producing a gas separation membrane according to an application example of the present disclosure includes: preparing a porous substrate including a first porous layer and a second porous layer that are laminated to each other and supplying a raw material liquid to come into contact with the first porous layer to obtain a coating film; and applying energy to the coating film to obtain a separation layer formed of a polymer material and having a function of selecting and separating carbon dioxide, in which when a layer thickness of the first porous layer is denoted by T1, an average pore diameter of the first porous layer is denoted by d1, an aperture ratio of the first porous layer is denoted by A1, and a maximum height roughness of a surface of the first porous layer facing the separation layer is denoted by R1, the layer thickness T1 is 0.1 μm or more and 10.0 μm or less, the average pore diameter d1 is 10 nm or more and 10,000 nm or less, the aperture ratio A1 is 40% or more and 80% or less, and the maximum height roughness R1 is 1 nm or more and 200 nm or less, and when a layer thickness of the second porous layer is denoted by T2, an average pore diameter of the second porous layer is denoted by d2, and an aperture ratio of the second porous layer is denoted by A2, the layer thickness T2 is 10 μm or more and 1,000 μm or less, a ratio d2/d1 of the average pore diameter d2 to the average pore diameter d1 is 1.1 or more and 10,000 or less, and a ratio A2/A1 of the aperture ratio A2 to the aperture ratio A1 is 1.1 or more and 2.0 or less.

A gas separation apparatus according to an application example of the present disclosure includes: the gas separation membrane according to the application example of the present disclosure; a fixing portion configured to fix the gas separation membrane and to have an internal space formed on a porous substrate side of the gas separation membrane; and an exhaust unit configured to depressurize the internal space so as to be negative with respect to an external space on a separation layer side of the gas separation membrane.

### BRIEF DESCRIPTION OF THE DRAWINGS

FIG. 1 is a cross-sectional view schematically illustrating a gas separation membrane according to an embodiment.

FIG. 2 is a cross-sectional view schematically illustrating the gas separation membrane according to the embodiment.

FIG. 3 is a schematic view illustrating a method for measuring an average pore diameter in an observation image of a cross section of a first porous layer.

FIG. 4 is a schematic diagram illustrating a method for measuring an aperture ratio in the observation image of the cross section of the first porous layer.

FIG. 5 is a cross-sectional view schematically illustrating a gas separation membrane including a modified porous substrate (gas separation membrane according to a modification).

FIG. 6 is a process diagram illustrating a schematic configuration of a method for producing a gas separation membrane according to the embodiment.

FIG. 7 is a cross-sectional view illustrating a schematic configuration of a gas separation apparatus according to the embodiment.

FIG. 8 is Table 1 illustrating configurations of gas separation membranes in Examples and evaluation results of the gas separation membranes.

FIG. 9 is Table 2 illustrating configurations of gas separation membranes in Comparative Examples and evaluation results of the gas separation membranes.

### DESCRIPTION OF EMBODIMENTS

Hereinafter, a gas separation membrane, a method for producing a gas separation membrane, and a gas separation apparatus according to the present disclosure will be described in detail based on an embodiment shown in the accompanying drawings.

### 1. Overview of Gas Separation Membrane

First, a configuration of a gas separation membrane according to the embodiment will be described.

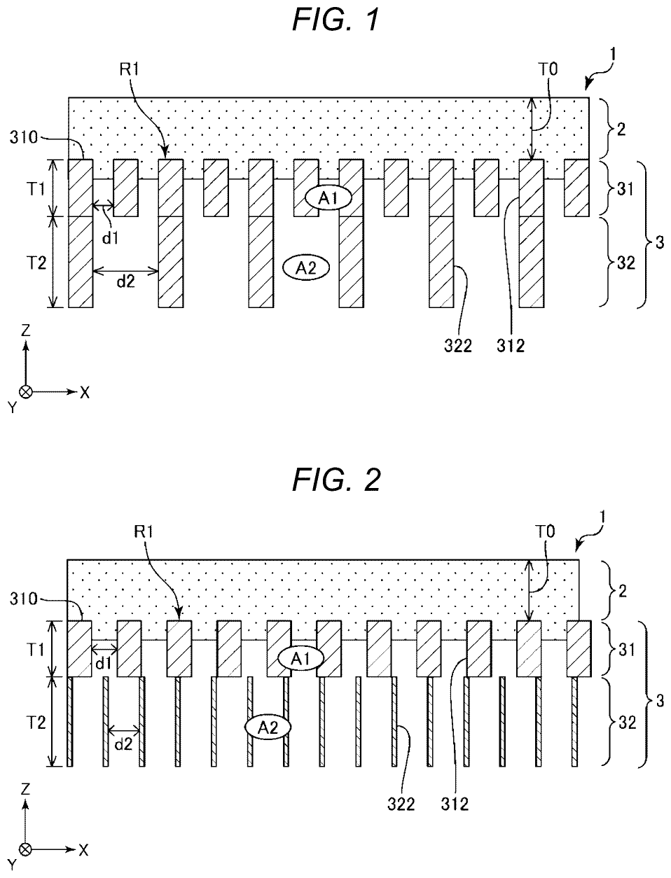

FIGS. 1 and 2 are cross-sectional views schematically illustrating a gas separation membrane 1 according to the embodiment. In FIGS. 1 and 2 of the present application, an X axis, a Y axis, and a Z axis are set as three axes orthogonal to one another, and are indicated by arrows. A base end of the arrow indicating each axis is designated as “minus” and a tip end as “plus”.

In the gas separation membrane 1 illustrated in FIGS. 1 and 2, a Z-axis plus side is referred to as “upper”, and a Z-axis minus side is referred to as “lower”. A mixed gas is supplied above the gas separation membrane 1. In the gas separation membrane 1 in FIGS. 1 and 2, carbon dioxide permeates from an upper side to a lower side and is separated.

The gas separation membrane 1 illustrated in FIGS. 1 and 2 is used to permeate and separate carbon dioxide from a mixed gas containing the carbon dioxide. The gas separation membrane 1 illustrated in FIGS. 1 and 2 includes a separation layer 2 and a porous substrate 3 that are laminated to each other in a Z-axis direction. The separation layer 2 is formed of a polymer and has a function of selecting and separating carbon dioxide. The porous substrate 3 is a sheet-shaped multilayer substrate extending along an X-Y plane, and includes a first porous layer 31 in contact with the separation layer 2 and a second porous layer 32 provided on the first porous layer 31 on a side opposite to the separation layer 2. Any member may be interposed between the first porous layer 31 and the second porous layer 32.

The porous substrate 3 has the following configuration.

First, a layer thickness of the first porous layer 31 is denoted by T1, an average pore diameter of the first porous layer 31 is denoted by d1, an aperture ratio of the first porous layer 31 is denoted by A1, and a maximum height roughness of an upper surface 310 (surface facing the separation layer 2) of the first porous layer 31 is denoted by R1. At this time, the layer thickness T1 is 0.1 μm or more and 10.0 μm or less, the average pore diameter d1 is 10 nm or more and 10,000 nm or less, the aperture ratio A1 is 40% or more and 80% or less, and the maximum height roughness R1 is 1 nm or more and 200 nm or less.

A layer thickness of the second porous layer 32 is denoted by T2, an average pore diameter of the second porous layer 32 is denoted by d2, and an aperture ratio of the second porous layer 32 is denoted by A2. At this time, the layer thickness T2 is 10 μm or more and 1,000 μm or less.

Further, a ratio of the average pore diameter d2 to the average pore diameter d1 is denoted by a ratio d2/d1 of the average pore diameter, and a ratio of the aperture ratio A2 to the aperture ratio A1 is denoted by a ratio A2/A1 of the aperture ratio. At this time, the ratio d2/d1 of the average pore diameter is 1.1 or more and 10,000 or less, and the ratio A2/A1 of the aperture ratio is 1.1 or more and 2.0 or less.

According to such a configuration, the gas separation membrane 1 having high gas selectivity and high gas permeability for carbon dioxide and having sufficient mechanical strength can be implemented.

FIG. 1 schematically illustrates an image of the porous substrate 3 when the ratio d2/d1 of the average pore diameter of the porous substrate 3 is relatively large within the above range.

FIG. 2 schematically illustrates an image of the porous substrate 3 when the ratio A2/A1 of the aperture ratio of the porous substrate 3 is relatively large within the above range.

The form of the gas separation membrane according to the present disclosure may be a sheet shape (flat plate shape) illustrated in FIGS. 1 and 2, a spiral shape, or a tubular shape.

### 1.1. Porous Substrate

The porous substrate 3 has a sheet shape and supports the separation layer 2. Accordingly, even when the separation layer 2 does not have sufficient mechanical properties, the porous substrate 3 supports the separation layer 2, thereby implementing the gas separation membrane 1 having excellent mechanical properties.

As described above, the porous substrate 3 includes the first porous layer 31 and the second porous layer 32. As described above, the first porous layer 31 is provided at a position in contact with the separation layer 2 and supports the separation layer 2. The second porous layer 32 is provided below the first porous layer 31.

### 1.1.1. First Porous Layer

The first porous layer 31 is formed of a porous material. The porous material is a material having a large number of pores 312 and has good gas permeability.

Examples of the porous material forming the first porous layer 31 include a ceramic material, a metal material, and a polymer material. The porous material may be a composite material of these materials and other materials.

Examples of the ceramic material include alumina, cordierite, mullite, silicon carbide, silicon oxide, and zirconia.

Examples of the metal material include stainless steel, a copper alloy, an aluminum alloy, and a titanium alloy.

Examples of the polymer material include polyolefin resins such as polyethylene and polypropylene, fluorine-containing resins such as polytetrafluoroethylene, polyvinyl fluoride and polyvinylidene fluoride, polystyrene, cellulose, cellulose acetate, cellulose nitrate, polycarbonate, polyurethane, polyacrylonitrile, polyphenylene oxide, polysulfone, polyethersulfone, polyimide, polyaramid, nylon, and polysiloxane.

The first porous layer 31 may be a filter having an open cell structure. The filter having an open cell structure is also called an absolute-type filter, and includes the pores 312 that are continuous from one surface to the other surface that are opposite to each other and are independent from each other.

The layer thickness T1 of the first porous layer 31 is 0.1 μm or more and 10.0 μm or less, preferably 0.3 μm or more and 7.0 μm or less, and more preferably 1.0 μm or more and 5.0 μm or less. When the layer thickness T1 is within the above range, the first porous layer 31 having good gas permeability and necessary and sufficient mechanical strength can be obtained.

When the layer thickness T1 of the first porous layer 31 falls below the lower limit value, the mechanical strength of the first porous layer 31 may decrease, and damage or the like may occur. In this case, the separation layer 2 cannot be sufficiently supported by the porous substrate 3, and the gas selectivity of the gas separation membrane 1 may decrease. On the other hand, when the layer thickness T1 of the first porous layer 31 exceeds the upper limit value, the pressure loss when gas passes through the pores 312 included in the first porous layer 31 increases, and the gas permeability of the first porous layer 31 decreases.

The layer thickness T1 of the first porous layer 31 is obtained as follows. First, a cross section of the first porous layer 31 is processed by focused ion beam processing or the like. Next, the obtained cross section is observed with a scanning electron microscope (SEM) or a scanning transmission electron microscope (STEM). Next, a range of the first porous layer 31 is extracted based on a contrast of the observation image. Next, the thickness of the extracted first porous layer 31 is measured at five locations. An average value of the measured thicknesses is defined as the layer thickness T1 of the first porous layer 31.

The average pore diameter d1 of the first porous layer 31 is 10 nm or more and 10,000 nm or less, preferably 20 nm or more and 1,000 nm or less, and more preferably 30 nm or more and 500 nm or less. When the average pore diameter d1 is within the above range, the first porous layer 31 having good gas permeability and necessary and sufficient mechanical strength can be obtained. When the separation layer 2 moderately penetrates into the pores 312 of the first porous layer 31, adhesion and coverage of the separation layer 2 are enhanced. As a result, the gas selectivity of the separation layer 2 is increased.

When the average pore diameter d1 of the first porous layer 31 falls below the lower limit value, the pressure loss when gas passes through the pores 312 included in the first porous layer 31 increases, and the gas permeability of the first porous layer 31 decreases. Since the permeation of the separation layer 2 can be prevented, the gas selectivity of the separation layer 2 decreases. On the other hand, when the average pore diameter d1 of the first porous layer 31 exceeds the upper limit value, the mechanical strength of the first porous layer 31 may decrease, and damage or the like may occur. In this case, the separation layer 2 cannot be sufficiently supported by the porous substrate 3, and the gas selectivity of the gas separation membrane 1 may decrease. Since the retention of the separation layer 2 decreases, the coverage of the separation layer 2 may decrease and the separation layer 2 may become more susceptible to damage.

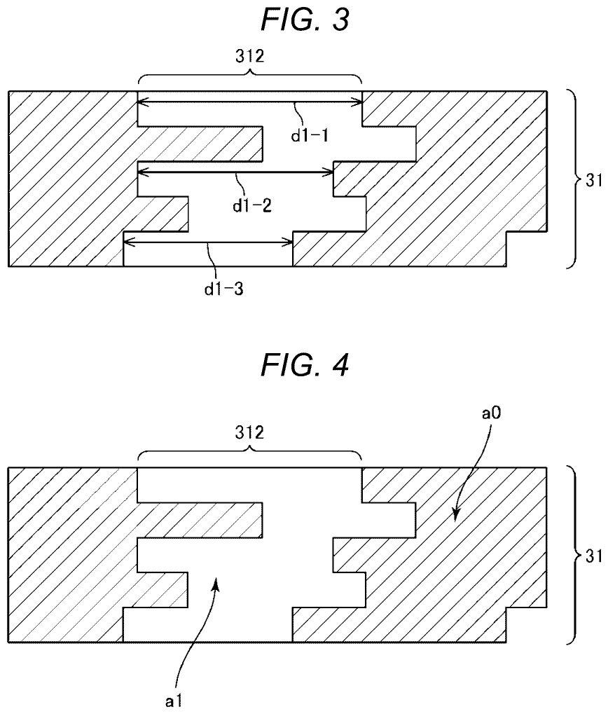

The average pore diameter d1 of the first porous layer 31 is obtained as follows. FIG. 3 is a schematic view illustrating a method for measuring the average pore diameter d1 in an observation image of the cross section of the first porous layer 31.

First, a cross section of the first porous layer 31 is processed by focused ion beam processing or the like. Next, the obtained cross section is observed with a scanning electron microscope (SEM) or a scanning transmission electron microscope (STEM). FIG. 3 is an example of the observation image obtained in this manner. Next, based on the contrast of the observation image, the range of the first porous layer 31 and the pores 312 penetrating through that range in a thickness direction are extracted. Next, inner diameters of the extracted pores 312 at three positions in the thickness direction (an inner diameter d1-1 closest to the separation layer 2, an inner diameter d1-2 at a central portion, and an inner diameter d1-3 closest to the second porous layer 32) are measured. Next, inner diameters of five pores 312 are similarly measured. An average value of the obtained 15 pieces of data is defined as the average pore diameter d1 of the first porous layer 31.

The aperture ratio A1 of the first porous layer 31 is 40% or more and 80% or less, and preferably 50% or more and 70% or less. When the aperture ratio A1 is within the above range, the first porous layer 31 having good gas permeability and necessary and sufficient mechanical strength can be obtained.

When the aperture ratio A1 of the first porous layer 31 falls below the lower limit value, the pressure loss when gas passes through the pores 312 included in the first porous layer 31 increases, and the gas permeability of the first porous layer 31 decreases. On the other hand, when the aperture ratio A1 of the first porous layer 31 exceeds the upper limit value, the mechanical strength of the first porous layer 31 may decrease, and damage or the like may occur. In this case, the separation layer 2 cannot be stably supported by the porous substrate 3, and the gas selectivity of the gas separation membrane 1 may decrease.

The aperture ratio A1 of the first porous layer 31 is obtained as follows. FIG. 4 is a schematic diagram illustrating a method for measuring the aperture ratio A1 in an observation image of the cross section of the first porous layer 31.

First, a cross section of the first porous layer 31 is processed by focused ion beam processing or the like. Next, the obtained cross section is observed with a scanning electron microscope (SEM) or a scanning transmission electron microscope (STEM). FIG. 4 is an example of the observation image obtained in this manner. Next, after binarization processing is performed on the observation image, the range of the first porous layer 31 and the pores 312 penetrating through that range in the thickness direction are extracted based on the contrast. Next, in the observation image, an area a1 of the pore 312 and an area a0 of the first porous layer 31 other than the pore 312 are measured. An area ratio is calculated by a calculation formula a1/a0×100, and the calculation result is defined as the aperture ratio A1 of the first porous layer 31.

The maximum height roughness R1 of the upper surface 310 (surface facing the separation layer 2) of the first porous layer 31 is 1 nm or more and 200 nm or less, preferably 3 nm or more and 150 nm or less, and more preferably 5 nm or more and 120 nm or less. When the maximum height roughness R1 of the upper surface 310 is within the above range, the coverage of the separation layer 2 can be sufficiently increased. An increase in difficulty of forming the first porous layer 31 can be prevented. When the maximum height roughness R1 of the upper surface 310 of the first porous layer 31 falls below the lower limit value, the difficulty of forming the first porous layer 31 increases. On the other hand, when the maximum height roughness R1 of the upper surface 310 of the first porous layer 31 exceeds the upper limit value, the continuity of the separation layer 2 formed on the upper surface 310 is impaired, and the coverage of the separation layer 2 decreases.

The maximum height roughness R1 of the upper surface 310 of the first porous layer 31 is obtained as follows.

First, the first porous layer 31 is set in a surface roughness measuring apparatus such that the upper surface 310 of the first porous layer 31 serves as an observation target surface. For example, a laser microscope equipped with a white interferometer is used as the measuring apparatus. Examples of such a laser microscope include VK-X3000 manufactured by Keyence Corporation. Then, the shape of the upper surface 310 is scanned at a magnification of 50 times. Accordingly, an image including information on an uneven shape of the upper surface 310 is acquired. Next, in the image, a highest point and a lowest point are specified in a range excluding the pores 312 of the first porous layer 31. Next, a height difference between the two points is calculated and the height difference is set as the maximum height roughness. That is, a maximum height difference is obtained in a portion excluding the pores 312 based on the measurement results of the uneven shape of the upper surface 310, and the maximum height difference is set as the maximum height roughness R1.

### 1.1.2. Second Porous Layer

The second porous layer 32 is formed of a porous material.

The porous material forming the second porous layer 32 is appropriately selected from the materials listed as the porous material forming the first porous layer 31 described above. The porous material forming the second porous layer 32 may be the same as or different from the porous material forming the first porous layer 31. The second porous layer 32 may also be a filter having an open cell structure.

The layer thickness T2 of the second porous layer 32 is 10 μm or more and 1,000 μm or less, preferably 10 μm or more and 200 μm or less, and more preferably 30 μm or more and 200 μm or less. When the layer thickness T2 is within the above range, the second porous layer 32 having good gas permeability and necessary and sufficient mechanical strength can be obtained. When the layer thickness T2 of the second porous layer 32 is less than the lower limit value, the mechanical strength of the second porous layer 32 may decrease, and damage or the like may occur. In this case, the separation layer 2 cannot be sufficiently supported by the porous substrate 3, and the gas selectivity of the gas separation membrane 1 may decrease. On the other hand, when the layer thickness T2 of the second porous layer 32 exceeds the upper limit value, the pressure loss when gas passes through pores 322 included in the second porous layer 32 increases, and the gas permeability of the second porous layer 32 decreases.

A method for measuring the layer thickness T2 of the second porous layer 32 is the same as the method for measuring the layer thickness T1 of the first porous layer 31.

The average pore diameter d2 of the second porous layer 32 is preferably 10 nm or more and 10,000 nm or less, more preferably 20 nm or more and 5,000 nm or less, and still more preferably 30 nm or more and 3,000 nm or less. When the average pore diameter d2 is within the above range, the second porous layer 32 having good gas permeability and necessary and sufficient mechanical strength can be obtained. When the average pore diameter d2 of the second porous layer 32 falls below the lower limit value, the pressure loss when gas passes through the second porous layer 32 increases, and the gas permeability of the second porous layer 32 may decrease. On the other hand, when the average pore diameter d2 of the second porous layer 32 exceeds the upper limit value, the mechanical strength of the second porous layer 32 may decrease, and damage or the like may occur.

A method for measuring the average pore diameter d2 of the second porous layer 32 is the same as the method for measuring the average pore diameter d1 of the first porous layer 31.

The aperture ratio A2 of the second porous layer 32 is preferably 40% or more and 80% or less, and more preferably 50% or more and 70% or less. When the aperture ratio A2 is within the above range, the second porous layer 32 having good gas permeability and necessary and sufficient mechanical strength can be obtained. When the aperture ratio A2 of the second porous layer 32 falls below the lower limit value, the pressure loss when gas passes through the second porous layer 32 increases, and the gas permeability of the second porous layer 32 may decrease. On the other hand, when the aperture ratio A2 of the second porous layer 32 exceeds the upper limit value, the mechanical strength of the second porous layer 32 may decrease, and damage or the like may occur.

A method for measuring the aperture ratio A2 of the second porous layer 32 is the same as the method for measuring the aperture ratio A1 of the first porous layer 31.

### 1.1.3. Relationship Between Configurations of First Porous Layer and Second Porous Layer

Each configuration of the first porous layer 31 and the second porous layer 32 satisfies the following relationship.

A ratio T2/T1 of the layer thickness T2 to the layer thickness T1 is preferably 1 or more and 10,000 or less, more preferably 2 or more and 2,000 or less, and still more preferably 5 or more and 1,000 or less. When the ratio T2/T1 of the layer thickness is within the above range, both the function of the first porous layer 31 in supporting the separation layer 2 and the gas permeability function of the second porous layer 32 can be achieved. Accordingly, even the thin separation layer 2 can be adequately supported, and the porous substrate 3 having sufficiently high gas permeability can be implemented. As a result, the gas separation membrane 1 that achieves both high gas selectivity and high gas permeability can be implemented.

When the ratio T2/T1 of the layer thickness falls below the lower limit value, the layer thickness T2 is relatively too small, or the layer thickness T1 is relatively too large, so that the balance may be lost and it may be difficult to achieve both the above functions. On the other hand, when the ratio T2/T1 of the layer thickness exceeds the upper limit value, the layer thickness T1 is relatively too small or the layer thickness T2 is relatively too large, so that the balance may be lost, and it may be difficult to achieve both the above functions.

The ratio d2/d1 of the average pore diameter d2 to the average pore diameter d1 is 1.1 or more and 10,000 or less, preferably 1.5 or more and 1,000 or less, and more preferably 2.0 or more and 500 or less. When the ratio d2/d1 of the average pore diameter is within the above range, the separation layer 2 moderately penetrates into the pores 312 of the first porous layer 31, the adhesion and coatability are enhanced even when the separation layer 2 is thin, and the gas permeability and mechanical strength of the second porous layer 32 can be sufficiently ensured. As a result, the gas separation membrane 1 having high gas selectivity and high gas permeability for carbon dioxide and having sufficient mechanical strength can be implemented.

When the ratio d2/d1 of the average pore diameter falls below the lower limit value, the average pore diameter d2 is relatively too small or the average pore diameter d1 is relatively too large, so that the balance is lost, the gas permeability of the second porous layer 32 decreases, the separation layer 2 cannot be stably supported by the first porous layer 31, and the gas selectivity of the gas separation membrane 1 decreases. On the other hand, when the ratio d2/d1 of the average pore diameter exceeds the upper limit value, the average pore diameter d2 is relatively too large or the average pore diameter d1 is relatively too small, so that the balance is lost, and the support of the first porous layer 31 by the second porous layer 32 and the mechanical strength of the second porous layer 32 is insufficient, the gas permeability of the first porous layer 31 decreases, and the permeation of the separation layer 2 becomes insufficient.

The ratio A2/A1 of the aperture ratio A2 to the aperture ratio A1 is 1.1 or more and 2.0 or less, and preferably 1.3 or more and 1.8 or less. When the ratio A2/A1 of the aperture ratio is within the above range, the separation layer 2 is stably supported by the first porous layer 31, the gas permeability required for the first porous layer 31 can be ensured, and the gas permeability and the mechanical strength of the second porous layer 32 can be sufficiently increased. As a result, the gas separation membrane 1 having high gas selectivity and high gas permeability for carbon dioxide and having sufficient mechanical strength can be implemented.

When the ratio A2/A1 of the aperture ratio falls below the lower limit value, the aperture ratio A2 is relatively too small or the aperture ratio A1 is relatively too large, so that the balance is lost, the gas permeability of the second porous layer 32 decreases, the separation layer 2 cannot be stably supported by the first porous layer 31, and the gas selectivity of the gas separation membrane 1 decreases. On the other hand, when the ratio A2/A1 of the aperture ratio exceeds the upper limit value, the aperture ratio A2 is relatively too large or the aperture ratio A1 is relatively too small, so that the balance is lost, and the mechanical strength of the second porous layer 32 becomes insufficient, and the gas permeability of the first porous layer 31 decreases.

### 1.1.4. Modified Porous Substrate 3

Next, a gas separation membrane according to a modification will be described.

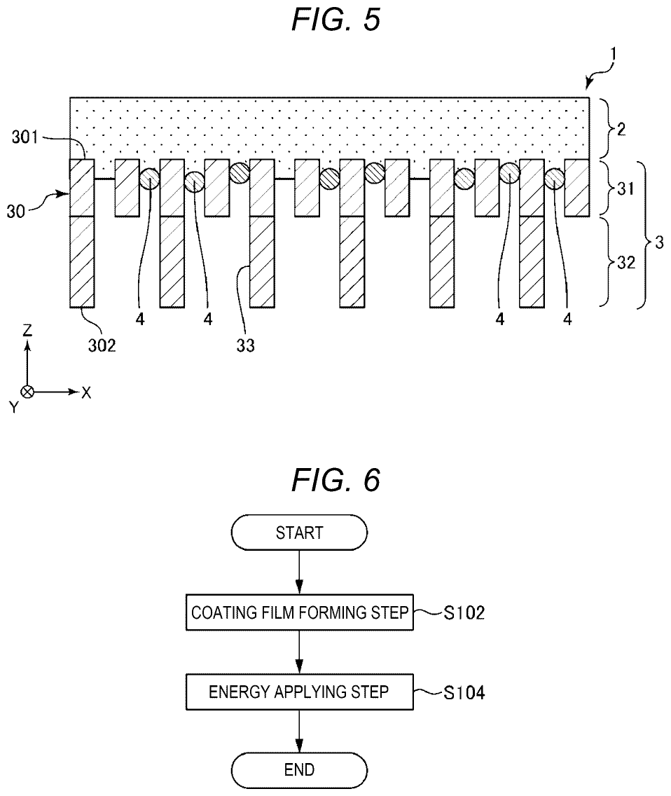

FIG. 5 is a cross-sectional view schematically illustrating the gas separation membrane 1 including the modified porous substrate 3 (gas separation membrane according to the modification).

Hereinafter, the gas separation membrane 1 according to the modification will be described, but in the following description, differences from the above-described gas separation membrane 1 will be mainly described, and description of the same matters will be omitted. In FIG. 5, the same reference numerals are given to substantially the same configurations as those in FIG. 1.

The porous substrate 3 illustrated in FIG. 5 is the same as the porous substrate 3 illustrated in FIG. 1 except that particles 4 are added.

The porous substrate 3 illustrated in FIG. 5 includes a porous sheet 30 and the particles 4. The porous sheet 30 has an upper surface 301 (one surface) and a lower surface 302 (the other surface) that are opposite to each other. Further, the porous sheet 30 is formed with a through pore 33 penetrating from the upper surface 301 to the lower surface 302. The particles 4 are inserted into the through pore 33.

According to such a configuration, the through pore 33 formed in the porous sheet 30 can be narrowed by the particles 4. Accordingly, an aperture ratio of the porous sheet 30 can be easily adjusted. Even when the porous sheet 30 having a single structure is used, the first porous layer 31 and the second porous layer 32 can be formed, and thus ease of production and cost reduction of the gas separation membrane 1 can be achieved.

In FIG. 5, the particles 4 are inserted from the upper surface 301 side of the porous sheet 30. Therefore, the particles 4 illustrated in FIG. 5 are caught in a portion of the through pore 33 on the upper surface 301 side and narrow an inner diameter of the portion. Therefore, in the porous sheet 30, a portion having a high density of the particles 4 is the first porous layer 31, and a portion having a lower density of the particles 4 is the second porous layer 32.

In the porous sheet 30 illustrated in FIG. 5, an average pore diameter is set to be smaller on the upper surface 301 side than on the lower surface 302 side. Accordingly, the particles 4 are easily caught on the portion of the porous sheet 30 on the upper surface 301 side. The average pore diameter of the porous sheet 30 may be constant in the thickness direction.

Examples of the particles 4 include alumina particles, silica particles, and silicone particles.

An average particle diameter of the particles 4 is appropriately set according to the inner diameter of the pore of the porous sheet 30, and is preferably 0.01 μm or more and 10 μm or less, and more preferably 0.1 μm or more and 5 μm or less.

The average particle diameter of the particles 4 refers to a particle diameter D50 when a cumulative frequency is 50% from a small diameter side in a cumulative particle size distribution on a volume basis of the particles 4 obtained using a laser diffraction type particle size distribution measurement device.

### 1.2. Separation Layer

The separation layer 2 is provided on the upper surface 310 of the first porous layer 31 of the porous substrate 3. The separation layer 2 has a function of selecting and separating carbon dioxide.

A constituent material of the separation layer 2 is a polymer material. Examples of the polymer material include polyolefin resins such as polyethylene and polypropylene, fluorine-containing resins such as polytetrafluoroethylene, polyvinyl fluoride, and polyvinylidene fluoride, polystyrene, cellulose, cellulose acetate, polyurethane, polyacrylonitrile, polyphenylene oxide, polysulfone, polyethersulfone, polyimide, polyaramid, organopolysiloxane, polyethylene terephthalate (PET), polyacetal (POM), and polylactic acid (PLA). The constituent material of the separation layer 2 may be a composite material of two or more of these materials.

Among them, an organopolysiloxane is preferably used as the constituent material of the separation layer 2. One molecule of the organopolysiloxane includes at least a unit (a T unit) represented by R¹SiO_{3/2}, a unit (a D unit) represented by R²R³SiO_{2/2}, and a unit (an M unit) represented by R⁴R⁵R⁶SiO_{1/2} as a basic constituent unit. In each unit, R¹ to R⁶ are an aliphatic hydrocarbon or a hydrogen atom. The organopolysiloxane is formed by combining the T unit, the D unit, and the M unit.

Specific examples of the organopolysiloxane include polydimethylsiloxane, polymethylphenylsiloxane, polydiphenylsiloxane, a polysulfone/polyhydroxystyrene/polydimethylsiloxane copolymer, a dimethylsiloxane/methylvinylsiloxane copolymer, a dimethylsiloxane/diphenylsiloxane/methylvinylsiloxane copolymer, a methyl-3,3,3-trifluoropropylsiloxane/methylvinylsiloxane copolymer, a dimethylsiloxane/methylphenylsiloxane/methylvinylsiloxane copolymer, vinyl terminated diphenylsiloxane/dimethylsiloxane copolymer, vinyl terminated polydimethylsiloxane, amino terminated polydimethylsiloxane, phenyl terminated polydimethylsiloxane, H terminated polydimethylsiloxane, and a dimethylsiloxane-methylhydrosiloxane copolymer. The expression “vinyl terminated” or the like indicates that at least one end of a main chain contained in the organopolysiloxane is substituted with a substituent such as a vinyl group. This includes a form in which a crosslinking reactant is formed. The constituent material of the separation layer 2 may be one kind or a composite of two or more kinds thereof, or may be a composite material containing an organopolysiloxane as a main component in mass ratio and other resin components in combination.

The organopolysiloxane has a good affinity for carbon dioxide. Therefore, the separation layer 2 containing an organopolysiloxane exhibits a high gas selectivity ratio to carbon dioxide.

If necessary, any functional group may be introduced into an upstream surface of the separation layer 2 using a coupling agent or the like. By appropriately selecting the functional group, the affinity for carbon dioxide can be further increased.

A layer thickness TO of the separation layer 2 is not particularly limited, and is preferably 1 nm or more and 1,000 nm or less, more preferably 3 nm or more and 800 nm or less, still more preferably 5 nm or more and 500 nm or less, and particularly preferably 10 nm or more and 200 nm or less. Accordingly, the separation layer 2 has good gas selectivity and gas permeability. As a result, the gas separation membrane 1 that can reduce an input amount of energy required for separating carbon dioxide, specifically, that can reduce a pressure difference between pressures upstream and downstream of the gas separation membrane 1 can be implemented. When the layer thickness TO of the separation layer 2 falls below the lower limit value, the coverage of the separation layer 2 may decrease or the separation layer 2 may be easily damaged, and the gas selectivity of the separation layer 2 may decrease. On the other hand, when the layer thickness TO of the separation layer 2 exceeds the upper limit value, the gas permeability of the separation layer 2 may decrease, the input amount of energy required for separation may increase, and flexibility of the separation layer 2 may decrease.

The layer thickness TO of the separation layer 2 can be obtained, for example, by observing a cross section of the gas separation membrane 1 under magnification and averaging thicknesses at 10 locations. For the magnification observation, for example, a scanning electron microscope (SEM), or a scanning transmission electron microscope (STEM) is used. The thickness of the separation layer 2 may be measured by depth direction analysis using X-ray photoelectron spectroscopy, and the measured value may be set as the layer thickness TO of the separation layer 2.

### 1.3. Another Configuration

The gas separation membrane 1 according to the embodiment has been described above, but any layer may be provided downstream of the porous substrate 3. For example, a porous plate having rigidity higher than that of the porous substrate 3 may be provided downstream of the porous substrate 3. The porous plate is formed with a large number of through holes such that the pressure loss of the gas passing therethrough is smaller than that of the porous substrate 3. Accordingly, the gas separation membrane 1 can be supported without inhibiting the gas selection function for carbon dioxide in the gas separation membrane 1.

Examples of the constituent material of the porous plate include a ceramic material, a metal material and a polymer material. The constituent material of the porous plate may be a composite material of these materials and other materials.

### 1.4. Characteristics of Gas Separation Membrane

Gas permeability R_{CO2} of the gas separation membrane 1 for carbon dioxide is preferably 5,000× 10⁻⁶ cm³ (STP)/cm²·sec·cmHg or more (5,000 GPU or more), and more preferably 10,000 GPU or more. Accordingly, the gas separation membrane 1 having high carbon dioxide separation efficiency can be obtained. The gas separation membrane 1 that can reduce an input amount of energy required for separation, specifically, that can reduce a pressure difference between pressures upstream and downstream of the gas separation membrane 1 can be implemented. The gas permeability R_{CO2} for carbon dioxide is measured by a method to be described later.

Gas permeability of the gas separation membrane 1 for nitrogen is defined as R_{N2}. At this time, a gas selectivity ratio R_{CO2}/R_{N2} of the gas separation membrane 1 is preferably 2 or more, and more preferably 5 or more. When the gas selectivity ratio R_{CO2}/R_{N2} is within the above range, the gas separation membrane 1 can efficiently separate and collect carbon dioxide in a mixed gas. On the other hand, the upper limit value of the gas selectivity ratio R_{CO2}/R_{N2} may not be set, and is preferably 40 or less from the viewpoint of enhancing the ease of producing the gas separation membrane 1.

### 2. Method for Producing Gas Separation Membrane

Next, a method for producing a gas separation membrane according to the embodiment will be described. In the following description, a method for producing the gas separation membrane 1 illustrated in FIG. 1 will be described as an example.

FIG. 6 is a process diagram illustrating a configuration of the method for producing a gas separation membrane according to the embodiment.

The method for producing a gas separation membrane illustrated in FIG. 6 includes a coating film forming step S102 and an energy applying step S104. According to such a production method, the gas separation membrane 1 can be efficiently produced. The steps will each be described below.

### 2.1. Coating Film Forming Step

In the coating film forming step S102, first, the porous substrate 3 including the first porous layer 31 and the second porous layer 32 that are laminated to each other is prepared. The porous substrate 3 may be, for example, a porous sheet body in which the average pore diameter, the aperture ratio, and the like vary in the thickness direction, or may be a porous substrate in which two sheet bodies having different average pore diameters, aperture ratios, and the like are joined. For joining the sheet bodies, for example, an adhesion method using an adhesive, or a direct joining method is used.

The porous substrate 3 may be a member obtained by subjecting the upper surface of a porous sheet body to a film forming process to reduce an average pore diameter and an aperture ratio, or by subjecting the lower surface of a porous sheet body to an etching process to increase an average pore diameter and an aperture ratio. As the film forming process, for example, when the constituent material of the sheet body is a metal, an anodic oxidation method or the like is exemplified. Examples of the etching process include a wet etching method.

The prepared porous substrate 3 is subjected to a cleaning process as necessary. Examples of the cleaning process include a plasma process, a corona process, an ozone process, and an ultraviolet irradiation process.

Next, a raw material liquid containing a raw material is supplied to come into contact with the first porous layer 31 to obtain a coating film. The raw material liquid includes a monomer (prepolymer), a solvent, and the like. The raw material liquid is applied to the upper surface 310 of the first porous layer 31 by various coating methods. Examples of the coating method include a dipping method, a dripping method, an inkjet method, a dispenser method, a spraying method, a screen printing method, a coater coating method, and a spin coating method. After the coating film is formed, the coating film is dried as necessary.

The raw material liquid does not have to permeate into the pore 312 of the first porous layer 31, and it is preferable that the raw material liquid permeates into the pore 312. Accordingly, the coating film is in close contact with the first porous layer 31, and the coatability by the coating film is further enhanced. As a result, the separation layer 2 having high coverage can be finally obtained.

### 2.2. Energy Applying Step

In the energy applying step S104, energy is applied to the obtained coating film. Examples of the method for applying energy include a method of irradiating with energy rays such as infrared rays, visible light, and ultraviolet rays, a method of irradiating with plasma, and a method of irradiating with an electron beam. Accordingly, the monomer is polymerized, and the coating film is cured or solidified. Thus, the separation layer 2 can be obtained.

In the energy applying step S104, the amount of energy to be applied may be adjusted such that a portion of a front surface (surface far from the porous substrate 3) of the obtained coating film is cured or solidified while a portion of the back surface remains uncured or unsolidified. In this case, the uncured or unsolidified coating film is removed by a cleaning liquid. Accordingly, a penetration depth of the separation layer 2 with respect to the pore 312 of the first porous layer 31 can be adjusted. As a result, the adhesion of the separation layer 2 to the first porous layer 31 can be increased, and a decrease in gas permeability of the porous substrate 3 can be prevented.

### 3. Use of Gas Separation Membrane

The gas separation membrane 1 according to the embodiment can be used for carbon dioxide separation and collection from a mixed gas containing the carbon dioxide, carbon dioxide separation and purification, and the like. In particular, it is effective to use the gas separation membrane 1 in a technique (direct air recovery (DAC) for separating and collecting carbon dioxide contained in the atmosphere.

### 4. Gas Separation Apparatus

Next, a gas separation apparatus according to the embodiment will be described.

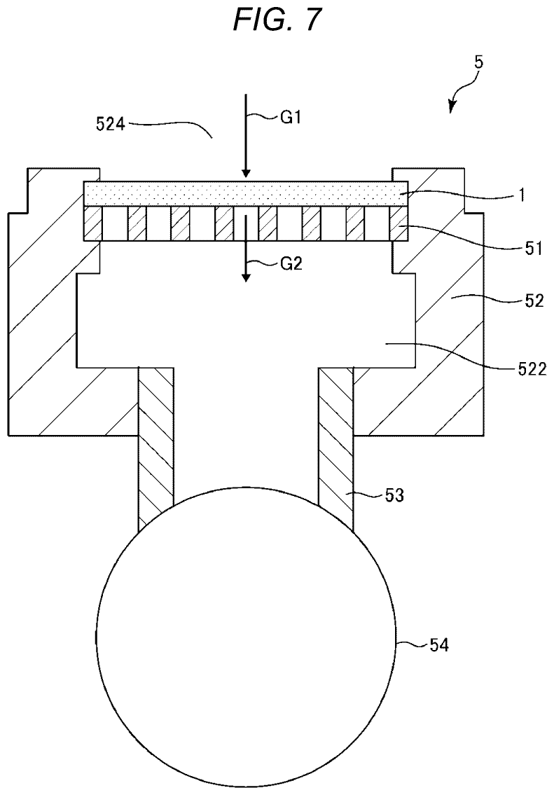

FIG. 7 is a cross-sectional view illustrating a schematic configuration of a gas separation apparatus 5 according to the embodiment.

The gas separation apparatus 5 illustrated in FIG. 7 includes the gas separation membrane 1, a fixing portion 52, a pipe 53, and an exhaust unit 54.

The fixing portion 52 fixes the gas separation membrane 1. The fixing portion 52 includes a porous plate 51 that supports the gas separation membrane 1. A large number of through holes are formed in the porous plate 51. The fixing portion 52 has an internal space 522 formed therein, which is located on the porous substrate 3 side of the gas separation membrane 1.

The exhaust unit 54 exhausts gas in the internal space 522 via the pipe 53. Accordingly, the pressure in the internal space 522 decreases, and the pressure becomes negative with respect to an external space 524 located on the separation layer 2 side of the gas separation membrane 1.

According to such a configuration, a mixed gas G1 supplied to the external space 524 can be transmitted to the gas separation membrane 1, and a permeation gas G2 can be collected. The mixed gas G1 is a mixed gas containing carbon dioxide and other gas components. The permeation gas G2 has a carbon dioxide concentration higher than that of the mixed gas G1. Accordingly, carbon dioxide can be separated and collected from the mixed gas G1.

The gas separation membrane 1 has high gas selectivity and high gas permeability for carbon dioxide and has sufficient mechanical strength. Therefore, the gas separation apparatus 5 having excellent carbon dioxide separation performance can be implemented.

### 5. Effects of Embodiment

The gas separation membrane 1 according to the embodiment is a gas separation membrane that permeates and separates carbon dioxide from a mixed gas containing the carbon dioxide, and includes the separation layer 2 and the porous substrate 3. The separation layer 2 is formed of a polymer material and has a function of selecting and separating carbon dioxide. The porous substrate 3 includes the first porous layer 31 in contact with the separation layer 2 and the second porous layer 32 provided on the first porous layer 31 on a side opposite to the separation layer 2.

The layer thickness of the first porous layer 31 is denoted by T1, the average pore diameter of the first porous layer 31 is denoted by d1, the aperture ratio of the first porous layer 31 is denoted by A1, and the maximum height roughness of the upper surface 310 (surface facing the separation layer 2) of the first porous layer 31 is denoted by R1. At this time, the layer thickness T1 is 0.1 μm or more and 10.0 μm or less, the average pore diameter d1 is 10 nm or more and 10,000 nm or less, the aperture ratio A1 is 40% or more and 80% or less, and the maximum height roughness R1 is 1 nm or more and 200 nm or less.

The layer thickness of the second porous layer 32 is denoted by T2, the average pore diameter of the second porous layer 32 is denoted by d2, and the aperture ratio of the second porous layer 32 is denoted by A2. At this time, the layer thickness T2 is 10 μm or more and 1,000 μm or less, the ratio d2/d1 of the average pore diameter d2 to the average pore diameter d1 is 1.1 or more and 10,000 or less, and the ratio A2/A1 of the aperture ratio A2 to the aperture ratio A1 is 1.1 or more and 2.0 or less.

According to such a configuration, the gas separation membrane 1 having high gas selectivity and high gas permeability for carbon dioxide and having sufficient mechanical strength can be obtained.

In the gas separation membrane 1 according to the embodiment, the ratio T2/T1 of the layer thickness T2 to the layer thickness T1 is preferably 1 or more and 10,000 or less.

According to such a configuration, both the function of the first porous layer 31 in supporting the separation layer 2 and the gas permeability function of the second porous layer 32 can be achieved. Accordingly, even the thin separation layer 2 can be adequately supported, and the porous substrate 3 having sufficiently high gas permeability can be implemented. As a result, the gas separation membrane 1 that achieves both high gas selectivity and high gas permeability can be implemented.

In the gas separation membrane 1 according to the embodiment, the separation layer 2 may contain an organopolysiloxane. The layer thickness TO of the separation layer 2 is preferably 1 nm or more and 1,000 nm or less.

According to such a configuration, the separation layer 2 that exhibits high gas selectivity for carbon dioxide can be obtained. When the layer thickness TO of the separation layer 2 is within the above range, the separation layer 2 having good gas selectivity and gas permeability for carbon dioxide can be obtained.

In the gas separation membrane 1 according to the embodiment, the porous substrate 3 may include the porous sheet 30 and the particles 4. The porous sheet 30 has the upper surface 301 (one surface) and the lower surface 302 (the other surface) that are opposite to each other. Further, the porous sheet 30 is formed with the through pore 33 penetrating from the upper surface 301 to the lower surface 302. Further, the particles 4 are inserted into the through pore 33.

According to such a configuration, the aperture ratio of the porous sheet 30 can be easily adjusted. Even when the porous sheet 30 having a single structure is used, the first porous layer 31 and the second porous layer 32 can be formed, and thus ease of production and cost reduction of the gas separation membrane 1 can be achieved.

The method for producing the gas separation membrane according to the embodiment includes the coating film forming step S102 and the energy applying step S104. In the coating film forming step S102, the porous substrate 3 including the first porous layer 31 and the second porous layer 32 that are laminated to each other is prepared, and the raw material liquid is supplied to come into contact with the first porous layer 31 to obtain a coating film. In the energy applying step S104, a process, in which energy is applied to the coating film, is performed to obtain the separation layer 2 formed of the polymer material and having a function of selecting and separating carbon dioxide.

The layer thickness of the first porous layer 31 is denoted by T1, the average pore diameter of the first porous layer 31 is denoted by d1, the aperture ratio of the first porous layer 31 is denoted by A1, and the maximum height roughness of the upper surface 310 (surface facing the separation layer 2) of the first porous layer 31 is denoted by R1. At this time, the layer thickness T1 is 0.1 μm or more and 10.0 μm or less, the average pore diameter d1 is 10 nm or more and 10,000 nm or less, the aperture ratio A1 is 40% or more and 80% or less, and the maximum height roughness R1 is 1 nm or more and 200 nm or less.

The layer thickness of the second porous layer 32 is denoted by T2, the average pore diameter of the second porous layer 32 is denoted by d2, and the aperture ratio of the second porous layer 32 is denoted by A2. At this time, the layer thickness T2 is 10 μm or more and 1,000 μm or less, the ratio d2/d1 of the average pore diameter d2 to the average pore diameter d1 is 1.1 or more and 10,000 or less, and the ratio A2/A1 of the aperture ratio A2 to the aperture ratio A1 is 1.1 or more and 2.0 or less.

According to such a configuration, the gas separation membrane 1 having high gas selectivity and high gas permeability for carbon dioxide and having sufficient mechanical strength can be efficiently produced.

The gas separation apparatus 5 according to the embodiment includes the gas separation membrane 1 according to the embodiment, the fixing portion 52, and the exhaust unit 54. The fixing portion 52 fixes the gas separation membrane 1. The fixing portion 52 has the internal space 522 formed on the porous substrate 3 side of the gas separation membrane 1. The exhaust unit 54 depressurizes the internal space 522 so as to be negative with respect to the external space 524 on the separation layer 2 side of the gas separation membrane 1.

According to such a configuration, the gas separation apparatus 5 having excellent carbon dioxide separation performance can be implemented.

The gas separation membrane, the method for producing a gas separation membrane, and the gas separation apparatus according to the present disclosure have been described above based on the preferred embodiment, but the present disclosure is not limited thereto.

For example, the gas separation membrane and the gas separation apparatus according to the present disclosure may be one in which each unit of the above-described embodiment is replaced with a constituent having substantially the same function, or may be one in which any constituents are added to the above-described embodiment.

The method for producing the gas separation membrane according to the present disclosure may be one in which any desired process is added to the above embodiment.

### EXAMPLE

Next, specific examples of the present disclosure will be described.

### 6. Preparation of Gas Separation Membrane

### 6.1. Example 1

First, a porous substrate formed of porous alumina was prepared. The porous substrate is a laminate of a first porous layer and a second porous layer having different layer thicknesses, average pore diameters, and aperture ratios.

Next, a raw material liquid was spin-coated to come into contact with the first porous layer to obtain a coating film. As the raw material liquid, a liquid containing a prepolymer of polydimethylsiloxane was used.

Next, the surface of the coating film was irradiated with ultraviolet light having a wavelength of 365 nm for 1 hour. Accordingly, the coating film was cured to obtain a gas separation membrane including a separation layer and a porous substrate.

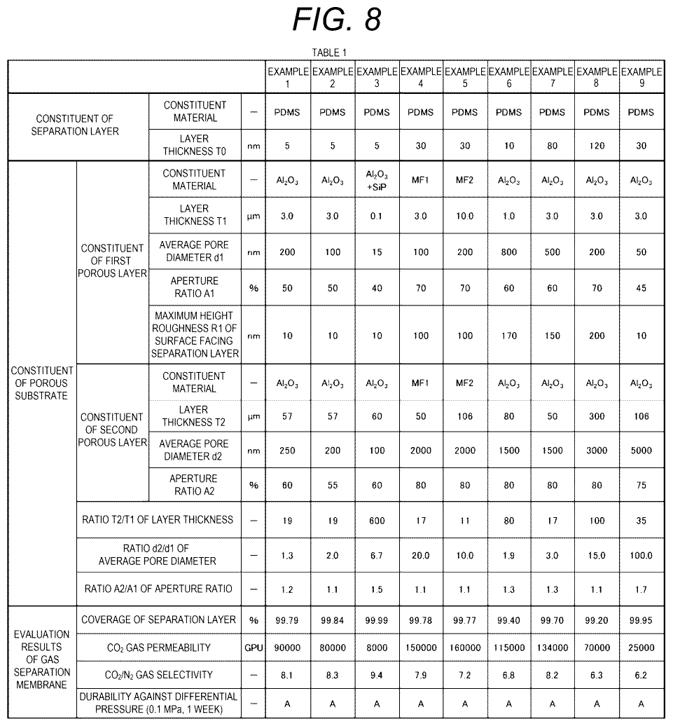

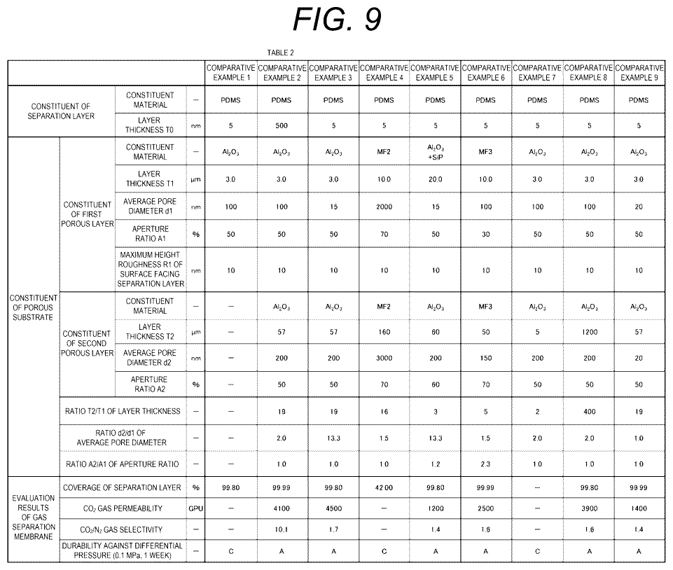

The configuration of the produced gas separation membrane is shown in Table 1 (FIG. 8).

### 6.2. Examples 2 to 9 and Comparative Examples 1 to 9

Gas separation membranes were obtained in the same manner as in Example 1 except that configurations of the gas separation membranes were changed as shown in Table 1 (FIG. 8) or Table 2 (FIG. 9). In the gas separation membrane in Comparative Example 1, the second porous layer was omitted.

FIG. 8 is Table 1 illustrating the configurations of the gas separation membranes in Examples and evaluation results of the gas separation membranes. FIG. 9 is Table 2 illustrating the configurations of the gas separation membranes in Comparative Examples and evaluation results of the gas separation membranes.

The abbreviations for the constituent materials shown in Tables 1 and 2 correspond to the following materials.
PDMS: polydimethylsiloxane
Al₂O₃: porous alumina membrane filter
Al₂O₃+SiP: porous alumina membrane filter with silicone particles packed into pores
MF1: membrane filter made of cellulose mixed ester (mixture of cellulose acetate and cellulose nitrate)
MF2: membrane filter made of regenerated cellulose
MF3: membrane filter made of polycarbonate

### 7. Evaluation of Gas Separation Membrane

The gas separation membrane in each Example and each Comparative Example was evaluated as follows.

### 7.1. Coverage of Separation Layer

The gas separation membrane in Examples and Comparative Examples s was subjected to cross-sectional machining by focused ion beam processing or the like. Next, the obtained cross section was observed with a scanning transmission electron microscope (STEM).

Next, based on the contrast of the observation image, a ratio of a length of a portion where the separation layer is defective to a length of an interface between the porous substrate and the separation layer was calculated. The ratio was defined as an area ratio X of the defect portion, and Coverage C of the separation layer was calculated by the following formula.

$$C [ \% ] = 100 [ \% ] - X [ \% ]$$

The calculation results are shown in Table 1 and Table 2.

### 7.2. CO₂ Gas Permeability

The gas separation membrane in each Example and each Comparative Example was cut into a circle having a diameter of 5 cm to prepare test samples. Next, using a gas permeability measuring apparatus, a mixed gas obtained by mixing carbon dioxide: nitrogen at a volume ratio of 5:95 was supplied upstream of the test sample. At this time, a total upstream pressure was adjusted to 1.2 atm, a flow rate of the mixed gas was adjusted to 500 mL/min, and a temperature was adjusted to 40° C. The gas permeability was measured according to a gas permeability test method (Part 1: differential pressure method) specified in JIS K 7126-1:2006. As the gas permeability measuring apparatus, GTR-11A/31A manufactured by GTR TEC Corporation was used. In the apparatus, gas that permeated the test sample is introduced into a gas chromatograph, and the gas permeability of each component is measured.

Next, the CO₂ gas permeability in each gas separation membrane was calculated based on the analysis result. The calculation results are shown in Table 1 and Table 2.

### 7.3. CO₂/N₂ Gas Selectivity

Based on the above-described analysis results, N₂ gas permeability of the gas separation membrane was calculated. A ratio of the CO₂ gas permeability to the N₂ gas permeability was calculated as CO₂/N₂ gas selectivity. The calculation results are shown in Table 1 and Table 2.

### 7.4. Durability Against Differential Pressure

The gas separation membrane in each Example and each Comparative Example was set in a gas permeability measuring apparatus, and the downstream pressure was depressurized such that a pressure difference (differential pressure) between pressures upstream and downstream was 0.1 MPa. Then, this state was maintained for one week.

After one week, the gas separation membrane was taken out and observed under magnification to check for any damage. Then, observation results were evaluated in view of the following evaluation criteria. The evaluation results are shown in Tables 1 and 2.
A: No damage was observed in the gas separation membrane.
C: Damage was observed in the gas separation membrane.

As is clear from Table 1 and Table 2, it was confirmed that the gas separation membranes in each Example had high gas selectivity and high gas permeability for carbon dioxide and had excellent mechanical strength.

What is claimed is:

1. A gas separation membrane for permeating and separating carbon dioxide from a mixed gas containing the carbon dioxide, the gas separation membrane comprising:
a separation layer formed of a polymer material and having a function of selecting and separating carbon dioxide; and
a porous substrate including a first porous layer in contact with the separation layer and a second porous layer provided on the first porous layer on a side opposite to the separation layer, wherein
when a layer thickness of the first porous layer is denoted by T1, an average pore diameter of the first porous layer is denoted by d1, an aperture ratio of the first porous layer is denoted by A1, and a maximum height roughness of a surface of the first porous layer facing the separation layer is denoted by R1,
the layer thickness T1 is 0.1 μm or more and 10.0 μm or less,
the average pore diameter d1 is 10 nm or more and 10,000 nm or less,
the aperture ratio A1 is 40% or more and 80% or less, and
the maximum height roughness R1 is 1 nm or more and 200 nm or less, and
when a layer thickness of the second porous layer is denoted by T2, an average pore diameter of the second porous layer is denoted by d2, and an aperture ratio of the second porous layer is denoted by A2,
the layer thickness T2 is 10 μm or more and 1,000 μm or less,
a ratio d2/d1 of the average pore diameter d2 to the average pore diameter d1 is 1.1 or more and 10,000 or less, and
a ratio A2/A1 of the aperture ratio A2 to the aperture ratio A1 is 1.1 or more and 2.0 or less.

2. The gas separation membrane according to claim 1, wherein
a ratio T2/T1 of the layer thickness T2 to the layer thickness T1 is 1 or more and 10,000 or less.

3. The gas separation membrane according to claim 1, wherein
the separation layer contains an organopolysiloxane, and
a layer thickness of the separation layer is 1 nm or more and 1,000 nm or less.

4. The gas separation membrane according to claim 1, wherein
the porous substrate includes
a porous sheet having one surface and the other surface that are opposite to each other and formed with a through pore penetrating from the one surface to the other surface, and
particles inserted into the through pore.

5. A method for producing a gas separation membrane, the method comprising:
preparing a porous substrate including a first porous layer and a second porous layer that are laminated to each other and supplying a raw material liquid to come into contact with the first porous layer to obtain a coating film; and
applying energy to the coating film to obtain a separation layer formed of a polymer material and having a function of selecting and separating carbon dioxide, wherein
when a layer thickness of the first porous layer is denoted by T1, an average pore diameter of the first porous layer is denoted by d1, an aperture ratio of the first porous layer is denoted by A1, and a maximum height roughness of a surface of the first porous layer facing the separation layer is denoted by R1,
the layer thickness T1 is 0.1 μm or more and 10.0 μm or less,
the average pore diameter d1 is 10 nm or more and 10,000 nm or less,
the aperture ratio A1 is 40% or more and 80% or less, and
the maximum height roughness R1 is 1 nm or more and 200 nm or less, and
when a layer thickness of the second porous layer is denoted by T2, an average pore diameter of the second porous layer is denoted by d2, and an aperture ratio of the second porous layer is denoted by A2,
the layer thickness T2 is 10 μm or more and 1,000 μm or less,
a ratio d2/d1 of the average pore diameter d2 to the average pore diameter d1 is 1.1 or more and 10,000 or less, and
a ratio A2/A1 of the aperture ratio A2 to the aperture ratio A1 is 1.1 or more and 2.0 or less.

6. A gas separation apparatus comprising:
the gas separation membrane according to claim 1;
a fixing portion configured to fix the gas separation membrane and to have an internal space formed on a porous substrate side of the gas separation membrane; and
an exhaust unit configured to depressurize the internal space so as to be negative with respect to an external space on a separation layer side of the gas separation membrane.
